(19) United States
(12) Patent Application Publication
(10) Pub. No.: US 2010/0073718 A1
(43) Pub. Date: Mar. 25, 2010

(54) SALES DATA PROCESSING APPARATUS, STORE PRINTER SYSTEM AND COMPUTER PROGRAM PRODUCT

(75) Inventor: Kazuyoshi Toma, Tokorozawa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/555,095

(22) Filed: Sep. 8, 2009

(30) Foreign Application Priority Data
Sep. 24, 2008 (JP) 2008-243578

(51) Int. Cl. G06F 15/00

(52) U.S. Cl. 358/1.15

(57) ABSTRACT

A sales data processing apparatus is connected to another one or more sales data processing apparatuses and a plurality of printers via a communication network. Printer identification information and address information on the communication network is set on each printer. The sales data processing apparatus includes: a communication section to transmit and receive data to and from the printers and another one or more sales data processing apparatuses; a storage section to store a printer network table in which printer identification information and address information, for each printer are associated with one another; an inquiry section to transmit inquiry data for requesting the printer identification, information and address information set on each printer, to each printer; and an update section to update the printer network table when the printer identification information and address information are received from each printer in response to the inquiry data.

### BACKGROUND OF THE INVENTION

1. Field of the Invention

The present invention relates to a sales data processing apparatus, a store printer system and a computer program product.

2. Description of Related Art

A store printer system has been known, which includes plural sales data processing apparatuses, such as ECR (Electronic Cash Resister), and plural printers connected to the sales data processing apparatuses via a communication network. In such a store printer system, content of an order is printed by a printer corresponding to the order registered In ECR. For example, a printer is installed for each kitchen in a restaurant, and an order registered in ECR is printed by a printer of a kitchen corresponding to the order. In such a store printer system, each ECR is required to set address information of each printer on a network in a manner associated with a type of print data (for example, a type of order).

Parent Document 1 (Japanese Patent Application Laid-Open Publication No. 11-53143) discloses a technique of setting address information for a general network printer. According to this technique, when a set protocol containing an NIC address of a printer whose address is to be set is broadcasted to a network by a host device, a printer compares MAC address in the set protocol with its own MAC address, and changes its own address when both the MAC addresses are identical to each other.

However, there is no technique for automatically setting address information of a printer on ECR in the conventional store printer system, and the setting of the address information of a printer on ECR has been manually performed. Furthermore, ECR does not have any concept such as printer ID, and address information of a printer as a destination is used when a printer is set up in accordance with a type of print data. Therefore, when newly setting up a printer or when changing a destination printer, for example, an administrator is required to manually set address information of the printer corresponding to a type of print data in each ECR, and thus the management is very cumbersome. Furthermore, the address information of each printer must be fixed due to the management as described above, and thus it is impossible to automatically allocate address information by using DHCP (Dynamic Host Configuration Protocol) or the like.

### SUMMARY OF THE INVENTION

It is, therefore, a main object of the present invention to facilitate setting and management of address information of printers in a sales data processing apparatus in a store printer system in which plural sales data processing apparatuses and plural printers are connected to one another via a communication network.

According to a first aspect of the present invention, there is provided a sales data processing apparatus which is connected to another one or more sales data processing apparatuses and a plurality of printers via a communication network. Printer identification information and address information on the communication network are set on each of the printers. The sales data processing apparatus includes: a communication section to transmit and receive data to and from the printers and another one or more sales data processing apparatuses; a storage section to store a printer network table in which printer identification information and address information for each of the printers are associated with one another; an inquiry section to transmit inquiry data for requesting the printer identification information and address information set on each of the printers, to each of the printers through the communication section; and an update section to update the printer network table when the printer identification information and address information are received from each of the printers through the communication section in response to the inquiry data, the printer network table being updated based on the received printer identification information and address information.

According to a second aspect of the present invention, there is provided a store printer system, including: a plurality of sales data processing apparatuses installed in a store; and a plurality of printers connected to the sales data processing apparatuses via a communication network, printer identification, information and address information on the communication network being set on each of the printers, wherein each of the sales data processing apparatuses includes: a communication section to transmit and receive data to and from the printers and another one or more of the sales data processing apparatuses; a storage section to store a printer network table In which printer identification information and address Information for each of the printers are associated with one another; an inquiry section to transmit inquiry data for requesting the printer identification information and address information set on each of the printers, to each of the printers through the communication section; and an update section to update the printer network table when the printer identification information and address information are received from each of the printers through the communication section in response to the inquiry data, the printer network table being updated based on the received printer identification information and address information, wherein each of the printers includes: a communication section to transmit and receive data to and from the sales data processing apparatuses; and a response section to transmit the set printer identification information and address information to one or more of the sales data processing apparatuses through the communication section in response to the inquiry data when the inquiry data is received from one of the sales data processing apparatuses through the communication section.

According to a third aspect of the present invention, there is provided a computer program product readable by a computer and encoding instructions for executing a computer process, the computer being used for a sales data processing apparatus which is connected to another one or more sales data processing apparatuses and a plurality of printers via a communication network, printer identification information and address information on the communication network being set on each of the printers. The computer process includes: transmitting and receiving data, by a communication section, to and from the printers and another one or more sales data processing apparatuses; storing a printer network table in which printer identification information and address information for each of the printers are associated with one another, into a storage section; transmitting inquiry data for requesting the printer identification information and address information set on each of the printers, to each of the printers through the communication section; and updating the printer network table stored in the storage section when the printer identification information and address information are received from each of the printers through the communication section in response to the inquiry data, the printer network table being updated, based on the received printer identification information and address information.

According to the present invention, a sales data processing apparatus can easily set and manage address information of printers in a store printer system in which plural sales data processing apparatuses and plural printers are connected to one another through a communication network.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 shows an overall configuration of an exemplary store printer system according to embodiments of the present invention;

FIG. 2 shows a block diagram indicating a functional configuration of ECR shown in FIG. 1;

FIG. 3 shows an exemplary data structure of a PLU file stored in RAM shown in FIG. 2;

FIG. 4 shows an exemplary data structure of a printer connection table stored in RAM shown in FIG. 2;

FIG. 5 shows an exemplary data structure of a printer network table stored in RAM shown in FIG. 2;

FIG. 6 shows a block diagram indicating a functional configuration of a printer shown in FIG. 1;

FIG. 7 shows a flowchart of an IP address obtaining process executed by CPU shown in FIG. 6;

FIG. 8 shows a flowchart of a printer network table update process executed by CPU shown in FIG. 2;

FIG. 9 shows a flowchart of a received data process executed by CPU shown in FIG. 6;

FIG. 10 shows a detailed flowchart of a process in step T14 shown in FIG. 9;

FIG. 11 shows an exemplary data structure of a response packet;

FIG. 12 shows a flowchart for sharing the printer network table between ECRs shown in FIG. 1;

FIG. 13 shows a flowchart of an ECR control process executed by CPU shown in FIG. 2; and

FIG. 14 shows a flowchart of a print control process executed by CPU shown in FIG. 2.

### DESCRIPTION OF THE PREFERRED EMBODIMENTS

Preferred embodiments of the present invention will be described below in detail with reference to drawings.

First, reference will be made to a configuration of the embodiments.

### (Configuration of Store Printer System 100)

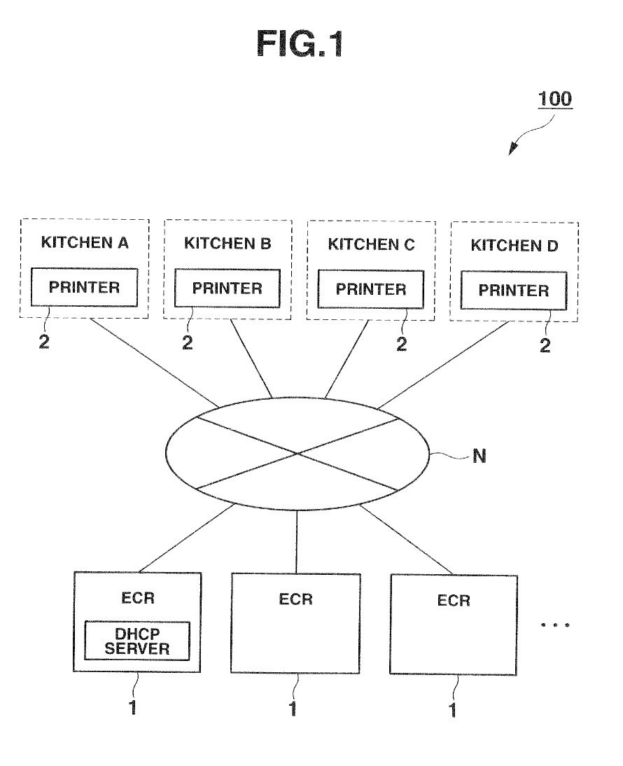

FIG. 1 shows an example of an overall configuration of a store printer system 100 according to the embodiments of the present invention.

As shown in FIG. 1, in the store printer system 100, plural ECRs 1 as sales data processing apparatuses installed in a store and plural printers 2 are connected to one another through a communication network N such as LAN (Local Network System) so that data can be transmitted and received among them. Any one of the plural ECRs 1 has a function of a DHCP server. ECR 1 having the DHCP server function will be hereinafter referred to as ECR 1A.

Although three ECRs 1 are connected to four printers 2 in this embodiment, no restriction is put on the number of the devices in the store printer system 100. Moreover, an IP network for performing communications based on the Internet protocol is used as the communication network N in this embodiment. However, no restriction is put on the type of network.

The store printer system 100 is installed in a store such as a restaurant. In this embodiment, four printers 2 are installed in a kitchen A, a kitchen B, a kitchen C and a kitchen D, respectively, in the store. Data of an order is transmitted as print data from each ECR 1 to a printer 2 of a kitchen corresponding to the ordered dish, and then printed by the printer 2.

### (Configuration of ECR 1)

ECR 1 performs registration of the order (registration process of sales data such as name (name of article), unit price, number of sales, sales proceeds, etc. of the ordered dish), accounting process, etc.

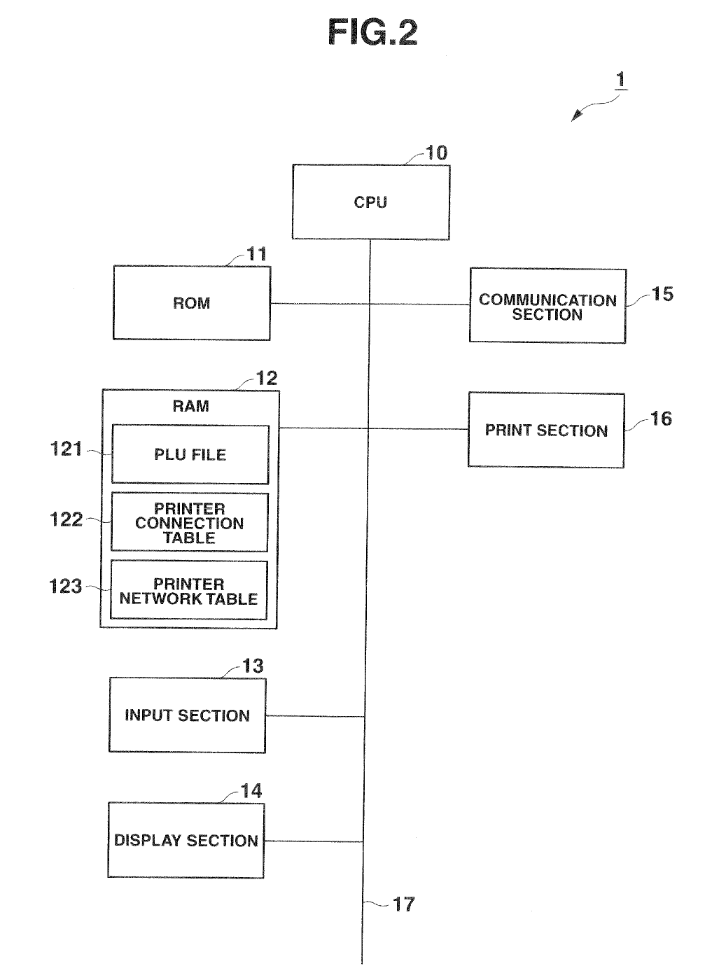

FIG. 2 shows an exemplary configuration of main elements of ECR 1.

As shown in FIG. 2, ECR 1 includes CPU (Central Processing Unit) 10, ROM (Read Only Memory) 11, RAM (Random Access Memory) 12, an input section 13, a display section 14, a communication section 15, a print section 16, and the respective sections are connected to one another through a bus 17.

CPU 10 reads out programs stored in ROM 11, loads the programs into a working area of RAM 12, and controls each of the units according to the programs. For example, CPU 10 executes various kinds of processes such as a printer network table update process, a transmission-side process, a reception-side process and a print control process, which will be described later, according to programs stored in ROM 11.

CPU 10 of ECR 1A implements the DHCP server function in cooperation with a DHCP server processing program stored in ROM 11. According to the DHCP server function, when an IP address is requested from the printer 2 on the basis of the DHCP protocol, an IP address is allocated to the printer as a request source.

ROM 11 includes a semiconductor non-volatile memory or the like. ROM 11 stores various kinds of processing programs executed by CPU 10, and data needed for these programs.

For example, ROM 11 stores various kinds of processing programs for executing the printer network table update process, the transmission-side process, the reception-side process and the print control process, which will be described later. ROM 11 also stores a main program for starting these processing programs in response to an input from the input section 13 or the communication section 15.

ROM 11 of ECR 1A stores a DHCP server processing program for allowing CPU 10 to execute the DHCP server function.

Each of the programs is stored in ROM 11 in the form of a computer readable program code. CPU 10 successively executes the operations following the program codes. That is, these programs are readable by CPU 10 of ECR 1, and encode instructions for executing various kinds of computer processes such as the printer network table update process, the transmission-side process, the reception-side process, and the print control process.

RAM 12 temporarily stores various kinds of programs read out from. ROM 11 by CPU 10, input or output data, parameters, etc.

RAM 12 also stores various kinds of files for preserving sales data, such as a PLU (Price Look Up) file 121.

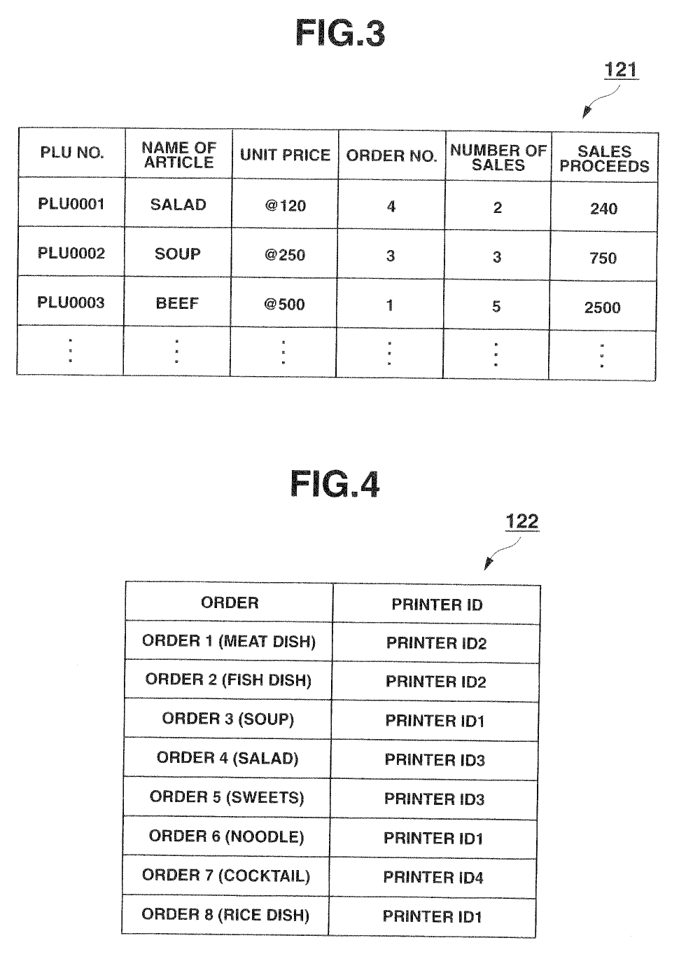

FIG. 3 shows an exemplary data structure of the PLU file 121.

The PLU file 121 is a file for storing sales data for each product. Specifically, the PLU file 121 stores PLU No., name of article, unit price, order No., the number of sales, and sale proceeds in a manner associated with one another for each article, as shown in FIG. 3.

RAM 12 stores a printer connection table 122.

FIG. 4 shows an exemplary data structure of the printer connection table 122.

As shown in FIG. 4, the printer connection table 122 stores a type of data to be printed (print data) (for example, order 1 (meat dish), order 2 (fish dish), etc.) and a printer ID of the printer 2 for printing the print data (for example, printer ID2, printer ID1, etc.) in a manner associated with one another.

RAM 12 stores a printer network table 123.

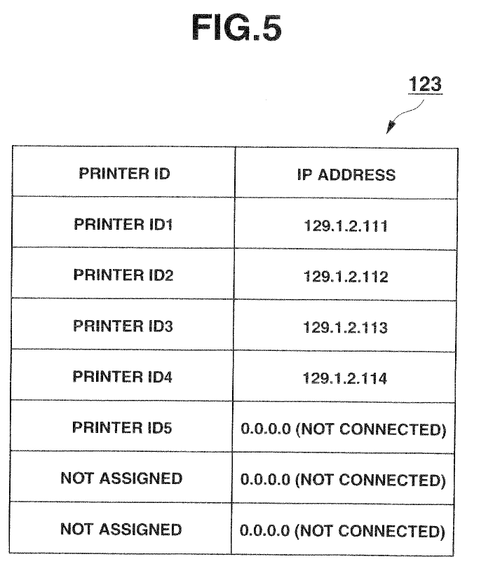

FIG. 5 shows an exemplary data structure of the printer network table 123.

As shown in FIG. 5, the printer network table 123 stores printer IDs of the respective printer 2 on the communication network N and IP addresses of the respective printers in a manner associated with one another. The IP address is identification information (address information) of a network device on the IP network.

The input section 13 is configured to include a keyboard for a cash register having a power source key, numeric keypad/function keys, a clerk key, etc., and outputs an operation signal corresponding to each key operation to CPU 10. The function key includes PLU keys for registering an ordered dish (article). PLU Nos. (PLU001, PLU002, etc.) are assigned to the respective PLU keys. When one of the PLU keys is pushed, the unit price of the article corresponding to the pushed PLU key is read out from the PLU file 121, and the sales data is registered.

The display section 14 Includes LCD (Liquid Crystal Display), an organic EL (Electro-Luminescence) display or the like, and displays various kinds of screens according to an instruction of a display signal from CPU 10.

The communication section 15 includes a LAN (Local Area Network) adapter or the like, and transmits and receives data to and from the other ECRs 1 and the printers 2 through the communication network N.

The print section 16 is a thermal printer (thermal-sensitive printer), for example, and has roll sheets (thermal-sensitive sheets) for receipts and for journals, and prints out data such as money amount on each roll sheet.

### (Configuration of Printer 2)

The printer 2 prints out content of an order registered in ECR 1. A printer ID as printer identification information is set on each printer for identifying each printer. In this embodiment, it is assumed that a printer ID1, a printer ID2, a printer ID3, and a printer ID4 are set for the printer 2 in the kitchen A, the printer 2 in the kitchen B, the printer 2 in the kitchen C, and the printer 2 in the kitchen D, respectively.

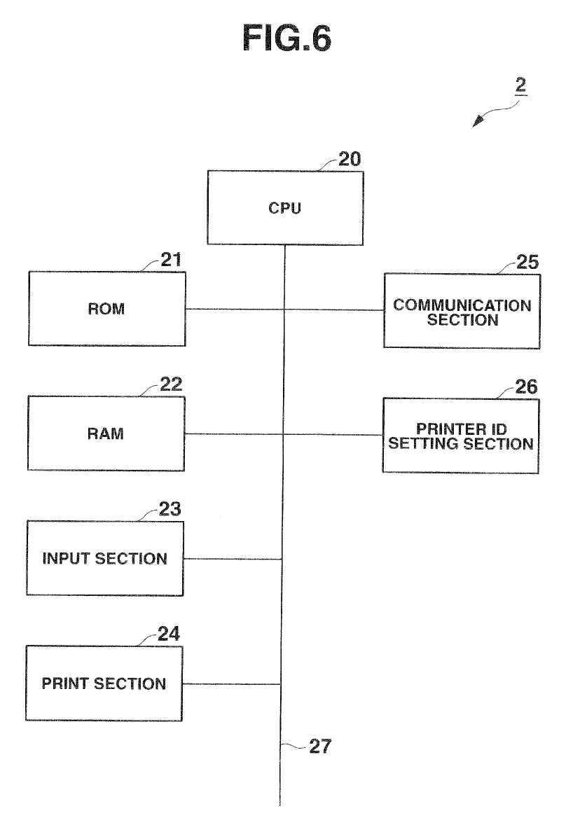

FIG. 6 shows an exemplary configuration of main elements of the printer 2.

As shown in FIG. 6, the printer 2 includes CPU 20, ROM 21, RAM 22, an input section 23, a print section 24, a communication section 25, a printer ID setting section 26, and the respective sections are connected to one another through a bus 27.

CPU 20 reads out programs stored in ROM 21, loads the programs into a working area of RAM 22, and controls each of the units according to the programs. For example, CPU 20 executes an IP address obtaining process and a received data process, which will be described later, according to the programs stored in ROM 21.

ROM 21 includes a semiconductor non-volatile memory or the like. ROM 21 stores various kinds of programs executed by CPU 20, data needed for these programs.

RAM 22 temporarily stores various kinds of programs read out from ROM 21 by CPU 20, input or output data, parameters, etc.

RAM 22 also stores various kinds of setting information and an IP address of this printer. For example, RAM 22 has an “MYIP” area (not shown) for saving the IP address.

The input section 23 includes a power source key, an install key, etc., and outputs an operation signal corresponding to each key operation to CPU 20. The install key is a key for inputting an instruction for initializing the setting of the printer 2 and booting up the printer 2 when a printer 2 is newly set up (installed). When the install key is pushed, an IP address is newly obtained.

The print section 24 prints out content of an order or the like on a sheet according to an instruction signal from CPU 20, for example.

The communication section 25 includes a LAN adapter or the like, and transmits and receives data to and from ECRs 1 through the communication network N.

The printer ID setting section 26 includes a dip switch or the like, and sets and preserves the printer ID of this printer.

### (Operation of Store Printer System 100)

Next, reference will now be made to an operation of each device in the store printer system 100. A printer ID is set and preserved in each printer 2 by the printer ID setting section 26 in advance.

First, setting of an IP address on each printer 2 will be described.

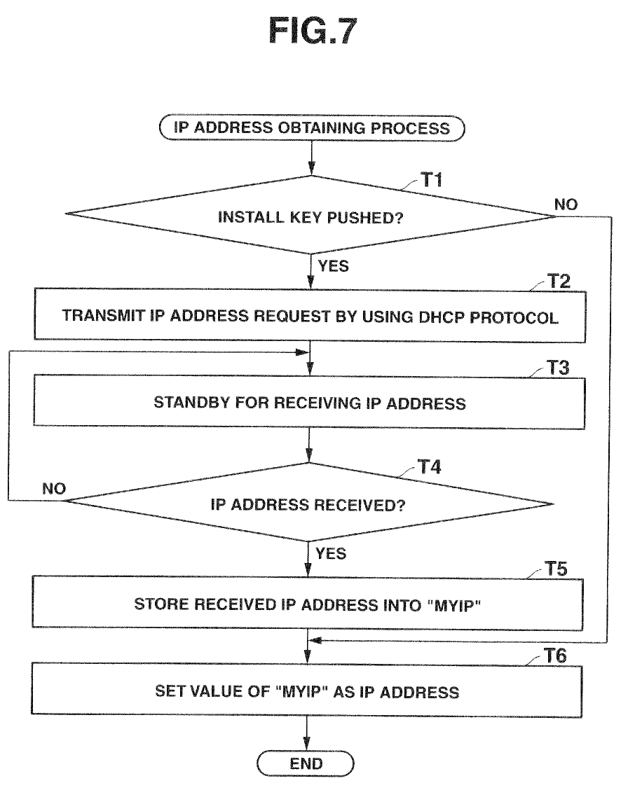

FIG. 7 is a flowchart showing the IP address obtaining process executed by CPU 20 of each printer 2.

The IP address obtaining process is executed in cooperation between CPU 20 and the IP address obtaining process program when the power source key is pushed.

In the IP address setting process, it is first determined whether the install key of the input section 23 is pushed or not (step T1). If the install key is pushed (step T1: YES), an IP address request is transmitted by the communication section 25 on the basis of the DHCP protocol (step T2). The IP address request is transmitted by simultaneous broadcast to the respective devices on the communication network N. The transmission by simultaneous broadcast means that data is transmitted to all devices on the communication network N.

When the IP address request is transmitted, the process proceeds to a stand-by state for receiving an IP address from the DHCP server (ECR 1A in this embodiment) (step T3). When the IP address transmitted from the DHCP server is received by the communication section 25 (step T4; YES), the received IP address is stored in the “MYIP” area of RAM 22 (step T5), and the process proceeds to step T6.

On the other hand, if the install key of the input section 23 is not pushed (step T1; NO), the process proceeds to step 76.

In step T6, the IP address stored in “MYIP” is set as an IP address of this printer, and the IP address obtaining process is finished.

Next, an operation of inquiring about an IP address to each printer 2 from one of the ECRs 1 to update the printer network table 123 of RAM 12 will be described.

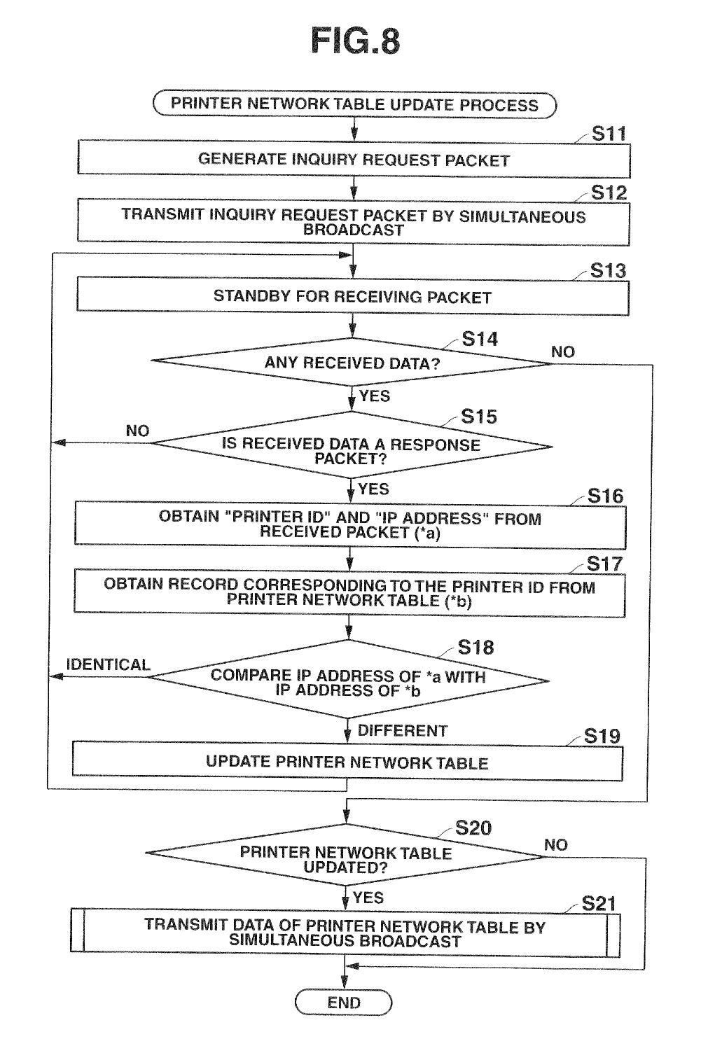

FIG. 8 is a flowchart of the printer network table update process executed by CPU 10 of ECR 1.

The printer network table update process is executed in cooperation between CPU 10 and the printer network table update processing program when the power source key is pushed, when an instruction is input through the input section 13, or when new ECR 1 is installed. An inquiry section, an update section and a printer network table transmission processing section are realized by this process.

First, an inquiry request packet for inquiring about an IP address and a printer ID to the printer 2 is generated (step S11) as inquiry data. The inquiry request packet has a value indicating an inquiry request packet in a packet header thereof, for example.

Next, the inquiry request packet is transmitted by simultaneous broadcast by the communication section 15 (step S12), and the process proceeds to a stand-by state for receiving a response packet from the printer 2 (step S13).

In each printer 2, data reception by the communication section 25 is monitored through received data process executed by CPU 20 when the power is on. When data is received by the communication section 25, the process corresponding to the received data is executed.

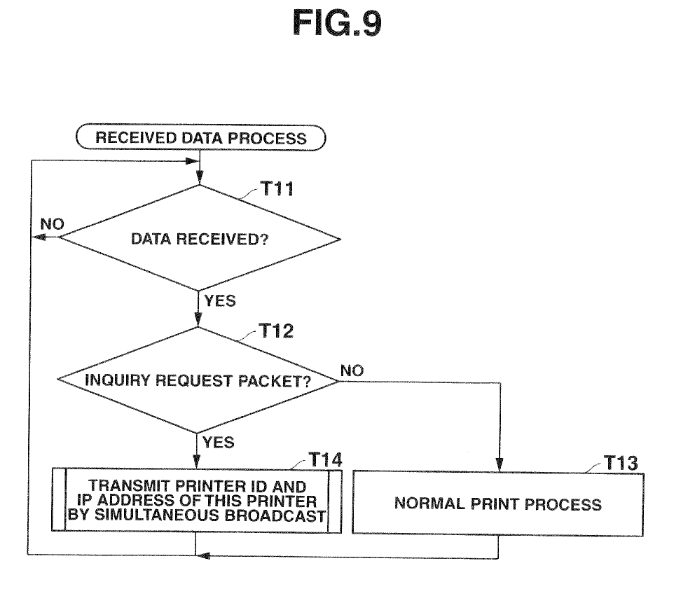

The received data process executed by CPU 20 of the printer 2 will be described with reference to FIG. 9.

FIG. 9 is a flowchart of the received data process.

This received data process is executed in cooperation between CPU 20 and the received data processing program. A response section is realized by this process.

When data is received by the communication section 25 (step T11; YES), the header of the received data (a packet header or the like) is referred to, and it is determined whether the received data is an inquiry request packet (step T12). This determination is made based on whether a value indicating the inquiry request packet is contained in the packet header of the received packet.

If the received data is not an inquiry request packet (step T12; NO), a normal print process is executed (step T13), and the process returns to step T11. In the print process, the ordered content is printed on a sheet by the print section 24 on the basis of the received data (print data).

On the other hand, if the received data is an inquiry request packet (step T12; YES), a response packet containing a printer ID and an IP address of this printer is transmitted by simultaneous broadcast by the communication section 25 (step T14), and the process returns to step T11.

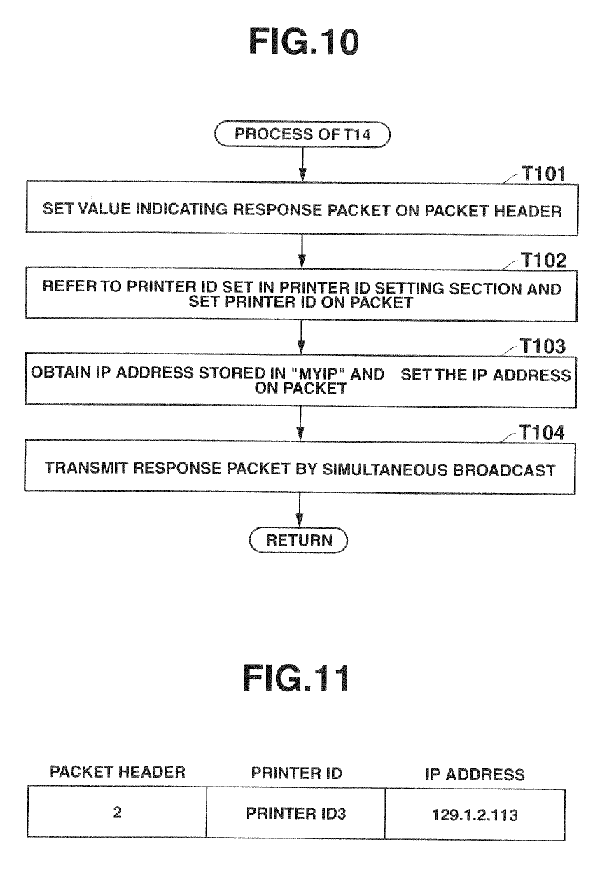

FIG. 10 shows a detailed flowchart of the process in step T14.

In step T14, the response packet is first generated. Specifically, a value indicating the response packet to an inquiry request packet described above is set on a packet header (step T101). Next, the printer ID which has been set in the printer ID setting section 26 is referred to and set on the response packet (step T102). Next, the IP address stored in the “MYID” area of RAM 22 is obtained and set on the response packet (step T103).

FIG. 11 shows an exemplary data structure of the response packet.

As shown in FIG. 11, the response packet has a packet header, “a printer ID” and “an IP address”. In the packet header, a value (in this case, “2”) indicating a response packet to an inquiry about an IP address and a printer ID is set. A printer ID of this printer is set in the “printer ID” of the packet, and an IP address of this printer is set in the “IP address” of the packet.

When the response packet is generated, the generated response packet is transmitted by simultaneous broadcast by the communication section 25 (step T104).

Returning to FIG. 8, when data is received by the communication section 15 (step S14; YES), the header of the received data (a packet header or the like) is referred to, and it is determined whether the received data is a response packet or not (step S15). If the received data is not a response packet (step S15; NO), the process returns to step S13.

If the received packet is a response packet (step S15; YES), “printer ID” and “IP address” are obtained from the received packet (step S18).

Next, a record (printer ID and IP address) whose printer ID is identical to the printer ID in the response packet is obtained from the printer network table 123 stored in RAM 12 (step S17), and the IP address of the obtained record is compared with the IP address in the received response packet (step S18). As a comparison result, if both of the IP addresses are identical to each other (step S18; identical), the process returns to step S13. If both of the IP addresses are different from each other (step S18; different), the IP address of the obtained record is overwritten with the IP address in the response packet to update the printer network table 123 stored in RAM 12 (step S19). In this case, the process returns to step S13 to be in a stand-by state for receiving the next response packet. In step S17, if there is no record whose printer ID is identical to the printer ID in the response packet, the printer ID and the IP address in the response packet are added to the printer network table 123 stored in RAM 12 to update the printer network table 123.

In step S14, if no data is received by the communication section 15 for a given period of time (step S14; NO), it is determined whether the printer network table 123 stored in RAM 12 is updated or not. If the printer network table 123 is determined to be updated (step S20; YES), all data of the updated printer network table 123 are transmitted by simultaneous broadcast by the communication section 15 (step S21). Then, the printer network table update process is finished.

In step S21, since the data of the updated printer network table 123 is transmitted by simultaneous broadcast, the updated printer network table 123 can be shared with the other ECRs 1 on the communication network N.

Reference will now be made in detail to the sharing of the printer network table 123 among ECRs 1.

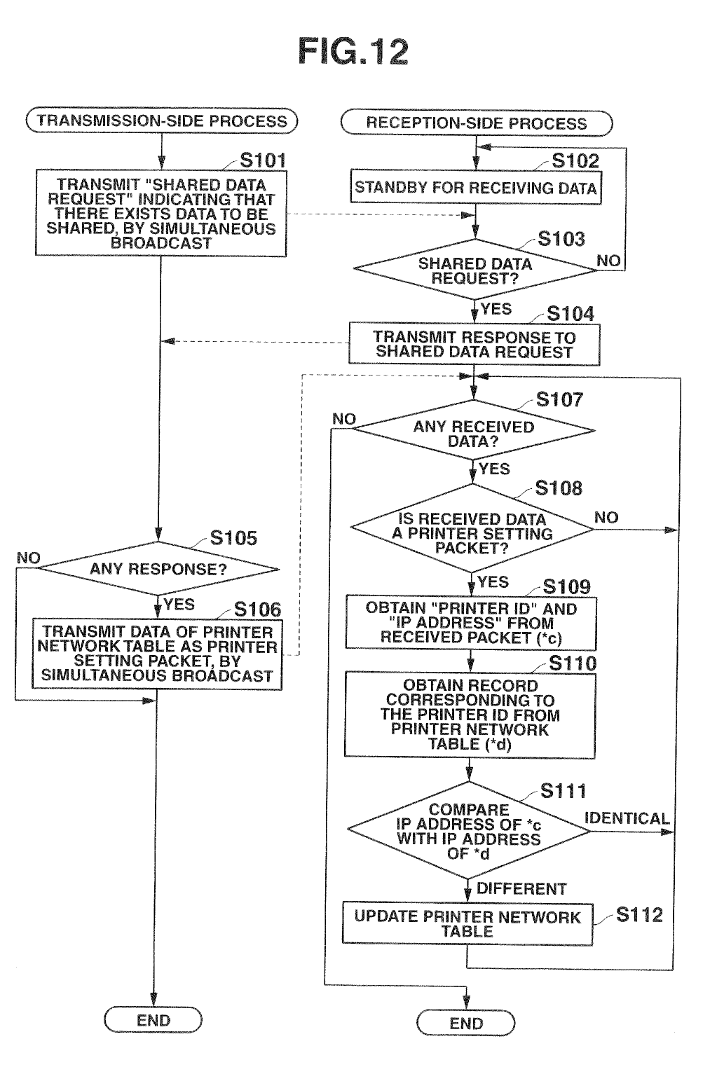

FIG. 12 shows a flowchart for sharing the printer network table 123 between ECRs 1.

The transmission-side and reception-side processes are executed in cooperation between CPU 10 of each ECR 1 and the programs stored in ROM 11. The transmission-side process in FIG. 12 corresponds to a detailed flowchart of step S21 of FIG. 8.

First, in ECR 1 on the transmission side, “shared data request” indicating that there exists data to be shared is transmitted by simultaneous broadcast by the communication, section 15 (step S101).

In ECR 1 on the reception side, the process is in a stand-by state for receiving data (step S102). When data is received by the communication section 15, it is determined whether the received data is a shared data request or not (step S103). If the received data is a shared data request (step S103; YES), a response to the shared data request is transmitted to ECR 1 on the transmission side by the communication section 15 (step S104). If the received data is not a shared data request (step S103; NO), the process returns to step S102.

In ECR 1 on the transmission side, if a response to the shared data request is received (step S105; YES), all data of the updated printer network table 123 stored in RAM 12 are transmitted by simultaneous broadcast by the communication section 15 (step S106). If at least one shared data request is received, all the data of the printer network table 123 are transmitted by simultaneous broadcast by the communication section 15. The data of the printer network table 123 is transmitted as a printer setting packet for each record. The printer setting packet includes a packet header, “a printer ID” and “an IP address” as with the response packet shown in FIG. 11. In the printer setting packet, a value indicating a printer setting packet is written at the packet header.

In ECR 1 on the reception side, when data is received by the communication section 15 (step S107; YES), the header of the received data (a packet header or the like) is referred to, and it is determined whether the received data is a printer setting packet. If the received data is not a printer setting packet (step S108; NO), the process returns to step S107.

On the other hand, if the received data is a printer setting packet (step S108; YES), “printer ID” and “IP address” are obtained from the received packet (step S109).

Next, a record (printer ID and IP address) whose printer ID is identical to the printer ID in the printer setting packet is obtained from the printer network table 123 stored in RAM 12 (step S110), and the IP address of the obtained record is compared with the IP address in the received printer setting packet (step S111). As a comparison result, if both of the IP addresses are determined to be identical to each other (step S111; identical), the process returns to step S107. If both of the IP addresses are different from each other (step S111; different), the IP address of the obtained record in the printer network table 123 is overwritten with the IP address of the printer setting packet, (step S112). Then, the process returns to step S107 to be in a stand-by state for receiving the next printer setting packet. In step S110, if there is no record whose printer ID is identical to the printer ID in the printer setting packet, the printer ID and the IP address in the printer setting packet are added to the printer network table 123 stored in RAM 12 to update the printer network table 123.

In step S107, if no data is received by the communication section 15 for a given period of time (step S107; NO), the process on the reception side is finished.

As described above, when one of the ECRs 1 inquires about an IP address and a printer ID of each printer 2 and the printer network table 123 is updated, the data of the updated printer network table 123 is transmitted by simultaneous broadcast. Accordingly, even ECR 1 which has not inquired about the IP address and printer ID of each printer 2 can receive the updated printer network table 123 and thus can update the printer network table 123 stored in RAM 12 of this ECR 1.

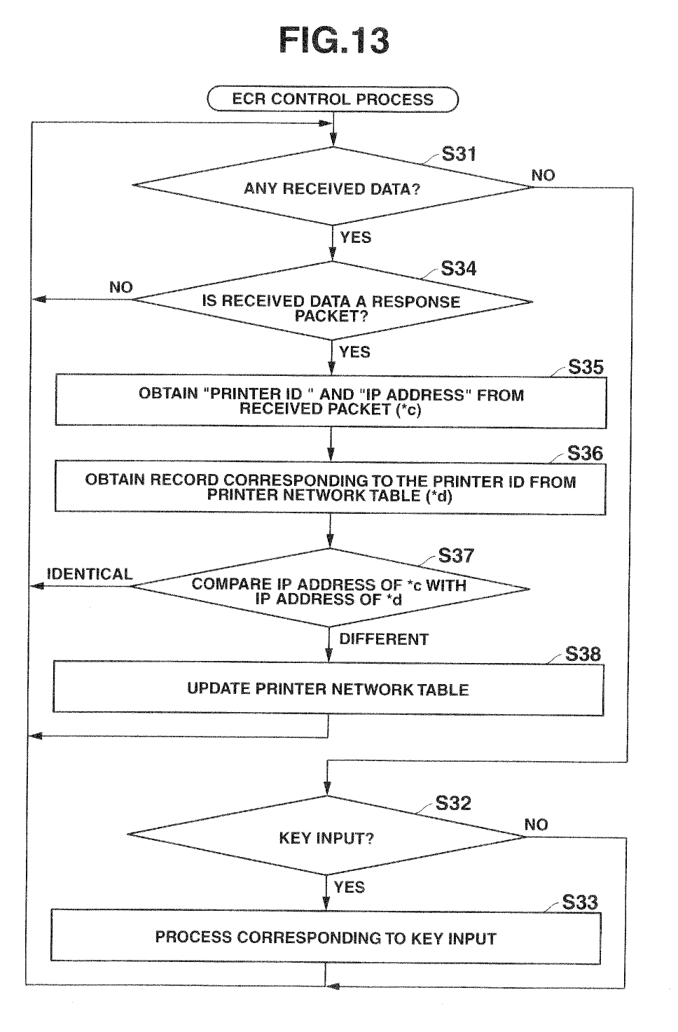

As described with reference to FIG. 9, when the inquiry request packet is received in each printer 2, the printer ID and the IP address of the printer are transmitted by simultaneous broadcast, and thus ECR 1 which does not inquiry about the IP address can also receive the response packet. Therefore, even if ECR 1 which has inquired about the IP address does not transmit the updated printer network table 123 by simultaneous broadcast, the printer network table 123 can be updated in the other ECRs 1 by executing an ECR control process shown in FIG. 13.

The ECR control process will now be described with reference to FIG. 13.

FIG. 13 shows a flowchart of the ECR control process.

This ECR control process is executed in cooperation between CPU 10 of ECR 1 and the ECR control processing program.

First, it is determined whether data is received by the communication section 15 (step S31). If no data is received by the communication section 15 (step 531; NO), it is also determined whether a key input is done through the input section 13 or not (step S32). If a key input is not done through the input section 13 (step S32; NO), the process returns to step S31. If a key input is done through the input section 13 (step S32; YES), the process corresponding to the key input is executed (step S33), and then the process returns to step S31.

On the other hand, if data is received by the communication section 15 (step S31; YES), it is determined whether the received data is a response packet (see FIG. 11) (step S34). If the received data is not a response packet (step S34; NO), the process returns to step 531. ECR 1A having the DHCP server function allocates an IP address when the received data is an IP address request, through this step is not shown in the drawings.

If the received data is a response packet (step S34; YES), “printer ID” and “IP address” are obtained from the received response packet (step S35).

Next, a record (printer ID and IP address) whose printer ID is identical to the printer ID in the response packet is obtained from the printer network table 123 stored in RAM 12 (step S36), and the IP address of the obtained record is compared with the IP address in the received response packet (step S37). As a comparison result, if both of the IP addresses are determined to be identical to each other (step S37; identical), the process returns to step S31. If both of the IP addresses are different from each other (step S37; different), the IP address of the obtained record in the printer network table 123 is overwritten with the IP address of the response packet (step S38), and then the process returns to step S31. In step S36, if there is no record whose printer ID is identical, to the printer ID in the response packet, the printer ID and the IP address in the response packet are added to the printer network table 123 stored in RAM 12 to update the printer network table 123.

Steps S31 to S38 of the ECR control process are Iterated until the power is off.

According to the ECR control process, when the response packet is received from the printer 2 in each ECR 1, the printer network table 123 stored in RAM 12 is updated on the basis of the printer ID and the IP address in the received response packet. Accordingly, even when ECR 1 which made an inquiry request of a printer ID and an IP address to each printer 2 does not transmit the updated printer network table 123 by simultaneous broadcast, the other ECRs 1 can update the printer network tables 123 on the basis of the response packet which is transmitted by simultaneous broadcast from the printer 2.

Next, reference will be made to the process of printing an order registered, in each ECR 1 by a printer 2 corresponding to the type of the order.

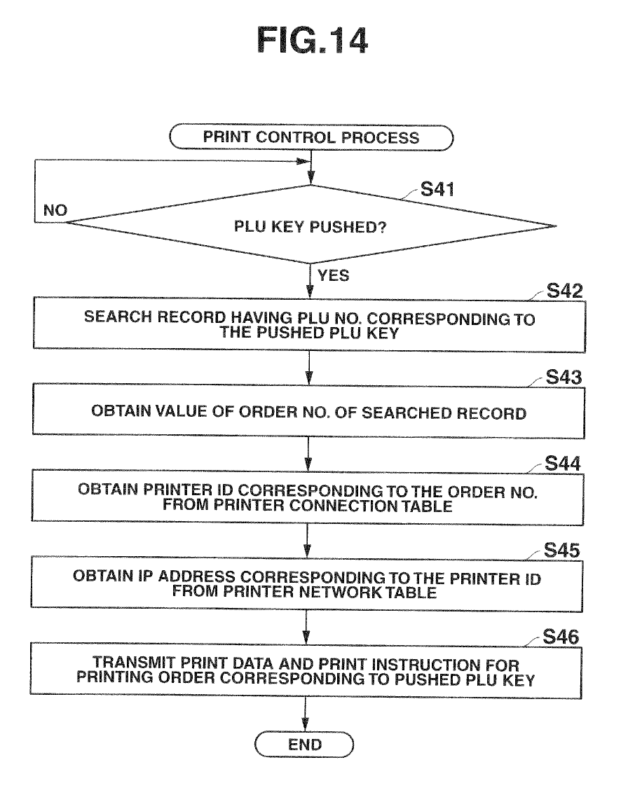

FIG. 14 shows a flowchart of the print control process executed by CPU 10 in response to an operation of the PLU key of the input section 13.

This print control process is executed, in cooperation between CPU 10 and the print control processing program stored in ROM 11.

When the PLU key is pushed (step S41; YES), a record having a PLU No. corresponding to the pushed PLU key is searched in the PLU file 121 (step S42), and a value set in the order No. of the searched record is obtained (step S43).

Next, the printer connection table 122 stored in RAM 12 is referred to, and a printer ID associated with the obtained order No. is obtained (step S44).

Next, the printer network table 123 stored in RAM 12 is referred to, and the IP address associated with the obtained printer ID is obtained (step S45).

Print data and a print instruction for printing the order (order No., name of article, price, number of article, etc.) corresponding to the PLU key pushed in step S41 are transmitted to the obtained IP address (step S46), and then the print control process is finished. In a printer 2 corresponding to the IP address, the content of the order is printed on a sheet by the print section 24 on the basis of the received print data through the received data process shown in FIG. 9.

For example, when the PLU key of PLU No. 0001 is pushed, the PLU file 121 is first referred to, and the order No. “4” corresponding to PLU No. 0001 is obtained. Next, the printer connection table 122 is referred to, and “printer ID3” corresponding to “order 4 (salad)” is obtained. Next, the printer network table 123 is referred to, and the IP address “129.1.2.113” corresponding to the printer ID3 is obtained. Print data and a print instruction for printing the order of salad are transmitted to the obtained IP address. The printer 2 having IP address “129.1.2.113” is in the kitchen C, and thus the order of salad is printed by the printer 2 in the kitchen C.

As described above, CPU 10 of ECR 1 of this embodiment transmits inquiry data for requesting a printer ID and an IP address through the communication section 15 to each printer 2 on the communication network N. When the printer ID and the IP address is received from, each printer 2 through the communication section 15 in response to the inquiry data, CPU 10 updates the printer network table which is stored in RAM 12 and associates the printer ID with, the IP address of each printer on the communication network N.

Accordingly, there is no need for an operator to manually set IP addresses of the printers 2 on the communication network N for ECR 1, and thus ECR 1 can easily set and manage the IP addresses of the printers 2.

Since CPU 10 of one ECR 1 causes the updated printer network table 123 to be transmitted, to the other ECRs 1, there is no need for all of the ECRs 1 to transmit inquiry data to the printers 2, and thus the printer network tables 123 of the respective ECRs 1 can efficiently be updated. Because the updated printer network, table 123 is transmitted to the other ECRs 1 by simultaneous broadcast, it is not necessary to transmit the printer network table 123 to the other ECRs 1 individually, so that the printer network table 123 can be transmitted to the other ECRs 1 with less processing load.

When transmitting inquiry data to the printers 2, the inquiry request packet for requesting a printer ID and an IP address of each of the printers 2 is transmitted by simultaneous broadcast to the printers 2. Therefore, it is not necessary to transmit the inquiry data to the printers 2 individually, and thus the inquiry data can be transmitted to each of the printers 2 with less processing load.

In ECR 1, the printer connection table 122 which associates the order type with the printer ID of the printer 2 for printing the order content is stored in RAM 12. When an order is registered through the input section 13, CPU 10 causes print data to be transmitted to the printer 2 corresponding to the registered order, on the basis of the printer connection table 122 and the printer network table 123 stored in RAM 12 to print out the content of the order. Accordingly, the printer 2 corresponding to the order type can print out the content of the order.

When CPU 20 of the printer 2 receives inquiry data from. ECR 1 through the communication section 25, CPU 20 causes the response packet containing the printer ID and the IP address of this printer to be transmitted by simultaneous broadcast. Accordingly, the ECRs 1 other than ECR 1 which has transmitted the inquiry data can receive the response packet, and the update of the printer network tables 123 in plural ECRs 1 can efficiently be performed.

The above detailed description is exemplary and explanatory only and is not restrictive of the invention, as claimed.

For example, in the above described embodiment, the store printer system 100 is installed in a restaurant. The store printer system 100 may be installed in any other stores, facilities, etc.

With respect to the detailed configurations and operations of the respective elements of the store printer system 100, it will be apparent to those skilled in the art that various modification and variations can be made without departing from the scope of the invention.

The entire disclosure of Japanese Patent; Application No. 2008-243578 filed on Sep. 24, 2008 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A sales data processing apparatus which is connected to another one or more sales data processing apparatuses and a plurality of printers via a communication network, printer identification information and address information on the communication network being set on each of the printers, the sales data processing apparatus, comprising:
a communication section to transmit and receive data to and from the printers and another one or more sales data processing apparatuses;
a storage section to store a printer network table in which printer identification information and address information for each of the printers are associated with one another;
an inquiry section to transmit inquiry data for requesting the printer identification information and address information set on each of the printers, to each of the printers through the communication section; and
an update section to update the printer network table when the printer identification information and address information are received from each of the printers through the communication section in response to the inquiry data, the printer network table being updated based on the received printer identification information and address information.

2. The sales data processing apparatus according to claim 1, further comprising a printer network cable transmission processing section to transmit the printer network table updated by the update section to another one or more sales data processing apparatuses through the communication section.

3. The sales data processing apparatus according to claim 2, wherein the printer network table transmission processing section transmits the printer network table updated by the update section to another one or more sales data processing apparatuses by simultaneous broadcast.

4. The sales data processing apparatus according to claim 1, wherein the inquiry section transmits an inquiry request packet for requesting the printer identification information and address information set on each of the printers, as the inquiry data, to each of the printers by simultaneous broadcast.

5. The sales data processing apparatus according to claim 1, wherein
the storage section further stores a printer connection table in which a type of print data and printer identification information of a printer for printing the print data are associated with one another,
wherein the sales data processing apparatus further comprises:
an input section to specify a type of print data; and
a print control section to cause one of the printers which corresponds to the type of print data specified by the input section, to print out the print data, based on the printer connection table and the printer network table stored in the storage section.

6. A store printer system, comprising:
a plurality of sales data processing apparatuses installed in a store; and
a plurality of printers connected to the sales data processing apparatuses via a communication network, printer identification information and address information on the communication network being set on each of the printers,
wherein each of the sales data processing apparatuses comprises:
a communication section to transmit and receives data to and from the printers and another one or more of the sales data processing apparatuses;
a storage section to store a printer network table in which printer identification information and address information for each of the printers are associated with one another;
an inquiry section to transmit inquiry data for requesting the printer identification information and address information set on each of the printers, to each of the printers through the communication section; and
an update section to update the printer network table when the printer identification information and address information are received from each of the printers through the communication section in response to the inquiry data, the printer network table being updated based on the received printer identification information and address information,
wherein each of the printers comprises:
a communication section to transmit and receive data to and from the sales data processing apparatuses; and
a response section to transmit the set printer Identification information and address information to one or more of the sales data processing apparatuses through the communication section in response to the inquiry data when the inquiry data is received from one of the sales data processing apparatuses through the communication section.

7. The store printer system according to claim 6, wherein the response section of each of the printers transmits the set printer identification information, and address information by simultaneous broadcast in response to the received inquiry data.

8. A computer program, product readable by a computer and encoding instructions for executing a computer process, the computer being used for a sales data processing apparatus which is connected to another one or more sales data processing apparatuses and a plurality of printers via a communication network, printer identification information and address information on the communication network being set on each of the printers, the computer process comprising:
transmitting and receiving data, by a communication section, to and from the printers and another one or more sales data processing apparatuses;
storing a printer network table in which printer identification information and address information for each of the printers are associated with one another, into a storage section;
transmitting inquiry data for requesting the printer identification information and address information set on each of the printers, to each of the printers through the communication section; and
updating the printer network table stored in the storage section when the printer identification information and address information are received from each of the printers through the communication section in response to the inquiry data, the printer network table being updated based on the received printer identification information and address information.
